(19) United States
(12) Patent Application Publication
(10) Pub. No.: US 2025/0300260 A1
(43) Pub. Date: Sep. 25, 2025

(54) PEELING APPARATUS FOR POSITIVE ELECTRODE CURRENT COLLECTOR AND POSITIVE ELECTRODE COMPOSITE

(71) Applicants: HONDA MOTOR CO., LTD., Tokyo (JP); NATIONAL UNIVERSITY CORPORATION KUMAMOTO UNIVERSITY, Kumamoto-shi (JP)

(72) Inventors: Takayuki Sakata, Wako-shi (JP); Mitsumasa Sorazawa, Wako-shi (JP); Yushi Fujinaga, Wako-shi (JP); Satoru Takahashi, Wako-shi (JP); Takao Namihira, Kumamoto-shi (JP); Ryo Sasamoto, Kumamoto-shi (JP)

(21) Appl. No.: 19/078,354

(22) Filed: Mar. 13, 2025

(30) Foreign Application Priority Data
Mar. 19, 2024 (JP) 2024-043171

(51) Int. Cl. H01M 10/54; B09B 3/80; B09B 101/16

(52) U.S. Cl. CPC H01M 10/54; B09B 3/80; B09B 2101/16

(57) ABSTRACT

Provided is a peeling apparatus for a positive electrode current collector and a positive electrode composite, the peeling apparatus including: a current-carrying area including an electrode; a shock wave delivery area configured to house a positive electrode plate; a partition plate configured to partition between both the areas; and a power supply device configured to supply electric power to the electrode, the peeling apparatus being configured to peel off the positive electrode composite from the positive electrode current collector of the positive electrode plate in such a manner that a discharge occurs between the electrode and the partition plate and a shock wave generated in the current-carrying area is delivered through the partition plate to the positive electrode plate in the shock wave delivery area.

### INCORPORATION BY REFERENCE

The present application claims priority under 35 U.S.C. § 119 to Japanese Patent Application No. 2024-043171 filed on Mar. 19, 2024. The content of the application is incorporated herein by reference in its entirety.

### BACKGROUND OF THE INVENTION

### Field of the Invention

The present invention relates to a peeling apparatus for a positive electrode current collector and a positive electrode composite.

### Description of the Related Art

Some of lithium ion batteries and solid-state batteries include a laminated electrode in which a positive electrode plate and a negative electrode plate are laminated with a separator interposed therebetween. The positive electrode plate of these batteries includes a positive electrode current collector and a positive electrode composite. An example of the positive electrode composite includes a ternary positive electrode material (NCM) containing nickel, cobalt, and manganese. It is desirable to recover valuable metals such as NCM at the time of battery disposal. The positive electrode composite adheres to aluminum foil serving as the positive electrode current collector using a binder contained in the positive electrode composite.

In the related art, a technique has been known in which a cut piece of a positive electrode plate formed by aluminum foil and a positive electrode composite is placed in water and shock waves are generated in the water by an electric pulse discharge to separate a foreign material (for example, see Japanese Patent Laid-Open No. 2023-086495).

However, when a cut piece of a positive electrode plate is placed in water and shock waves are generated in the water by an electric pulse discharge as in Japanese Patent Laid-Open No. 2023-086495, since the positive electrode plate contains an electrolyte, electric conductivity of the water is improved, resulting in weakening dielectric breakdown intensity and reducing a force of the shock waves.

Further, a part of a container in which the positive electrode plate is placed may be crushed by the shock waves generated by the electric pulse discharge, and metal of the container may be mixed in.

The present invention has been made in consideration of the above-described circumstances, and is to effectively separate a positive electrode current collector and a positive electrode composite from each other.

### SUMMARY OF THE INVENTION

An aspect of the present invention provides a peeling apparatus for a positive electrode current collector and a positive electrode composite, the peeling apparatus including: a current-carrying area including an electrode; a shock wave delivery area configured to house a positive electrode plate; a partition plate configured to partition between both the areas; and a power supply device configured to supply electric power to the electrode, the peeling apparatus being configured to peel off the positive electrode composite from the positive electrode current collector of the positive electrode plate in such a manner that a shock wave generated in the current-carrying area is delivered through the partition plate to the positive electrode plate in the shock wave delivery area.

An aspect of the present invention provides a peeling apparatus for a positive electrode current collector and a positive electrode composite, which can effectively separate the positive electrode current collector and the positive electrode composite from each other.

### BRIEF DESCRIPTION OF THE DRAWINGS

FIG. 1 is a schematic diagram of a target battery to which a battery treatment method of the present invention is applicable; and

FIG. 2 is a schematic diagram of a peeling apparatus for a positive electrode current collector and a positive electrode composite.

### DETAILED DESCRIPTION OF THE INVENTION

An embodiment of the present invention will be described below with reference to the drawings.

### Embodiment

### [1. Configuration of Target Battery]

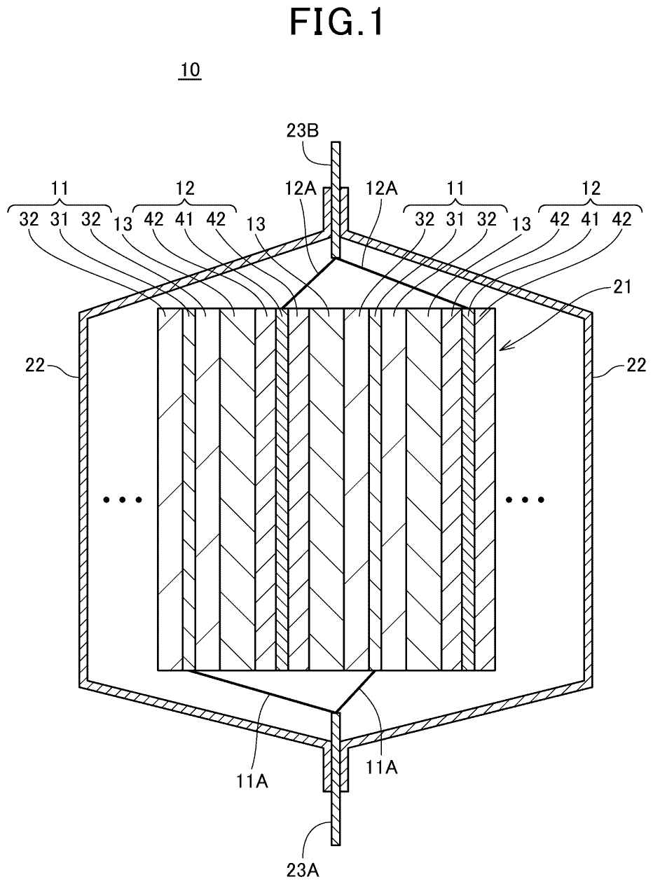

FIG. 1 is a diagram illustrating a configuration of a target battery 10 as an example of a target battery to which the present disclosure is applied, and shows a schematic cross section of the target battery 10. The target battery 10 is a secondary battery capable of charging and discharging. The target battery 10 according to the present embodiment is a laminated battery in which battery materials are enclosed in a laminate material 22, and has a flat plate shape as a whole. The target battery 10 can be referred to as a pouch battery, a laminated battery cell, a pouch battery cell, a lithium ion battery cell, a battery module, or the like.

The target battery 10 is a secondary battery known as a so-called lithium ion battery, and has been attracting attention as a power storage device having a high energy density. Examples of positive electrode active materials for the lithium ion battery may include lithium cobalt oxide, lithium nickel oxide, lithium manganese oxide, and lithium iron phosphate. An example of the positive electrode active material may include a ternary positive electrode material (NCM) containing nickel, cobalt, and manganese. As an negative electrode active material for the lithium ion battery, a carbon-based material is used, for example. A solid-state battery using a solid electrolyte as an electrolyte for the lithium ion battery is known.

Nickel, cobalt, and manganese, which are used as positive electrode active materials in the lithium ion battery and the solid-state battery, are known as valuable metals, and are demanded to be recovered from used batteries.

As illustrated in FIG. 1, the target battery 10 has a configuration in which a laminated electrode 21 is housed in the laminate material 22. The laminate material 22 is a laminate film a base material of which is a metal material, for example, an aluminum alloy or stainless steel. The laminate material 22 functions as an outer body of the target battery 10 and as a sealing body for sealing the laminated electrode 21.

The target battery 10 of the present embodiment has a flat plate shape in which two sheets of the laminate material 22 are bonded, and a pair of current collector tabs 23A and 23B for extracting electric power from the target battery 10 penetrate the outer body and are exposed from an end of the target battery 10.

The laminated electrode 21 is a multi-layer body in which positive electrode plates 11 and negative electrode plates 12 are laminated, and a separator 13 is disposed between the positive electrode plate 11 and the negative electrode plate 12. The separator 13 is disposed between the positive electrode plate 11 and the negative electrode plate 12, and prevents a short circuit between the positive electrode plate 11 and the negative electrode plate 12.

The positive electrode plates 11 and the negative electrode plates 12 are disposed alternately, and one positive electrode plate 11 and one negative electrode plate 12 facing each other form one electrode plate pair. A plurality of electrode plate pairs are stacked to form the laminated electrode 21.

The positive electrode plate 11 includes a positive electrode current collector 31 having a rectangular plate shape, and positive electrode composites 32 are provided on both surfaces of the positive electrode current collector 31. The positive electrode current collector 31 is an aluminum alloy or a pure aluminum material formed into a foil or plate shape. The positive electrode composite 32 contains, for example, a positive electrode active material, a conductive material, a conductive aid, and a binder. The positive electrode plate 11 includes a positive electrode terminal 11A extending from an end of the positive electrode plate 11. Each of the positive electrode terminals 11A extending from the plurality of positive electrode plates 11 forming the laminated electrode 21 is connected to the current collector tab 23A.

The negative electrode plate 12 includes a negative electrode current collector 41 having a rectangular plate shape. A negative electrode composite 42 is provided on a surface of the negative electrode current collector 41 facing the positive electrode plate 11. The negative electrode current collector 41 is made of, for example, copper foil. The negative electrode plate 12 includes a negative electrode terminal 12A extending from an end of the negative electrode plate 12. Each of the positive electrode terminals 12A extending from the plurality of negative electrode plates 12 forming the laminated electrode 21 is connected to the current collector tab 23B.

The current collector tabs 23A and 23B are formed from a thin-plate metal such as copper or aluminum, and pass between the two laminate materials 22 to be exposed outside.

When the target battery 10 is a lithium ion battery, the inside of the laminate materials 22 is filled with a liquid or gel electrolyte solution. The electrolyte solution contains, for example, an electrolyte, a solvent, and an additive. An example of the electrolyte may be a lithium salt such as lithium hexafluorophosphate (LiPF₆). An example of the solvent and the additive may be a carbonate ester such as ethylene carbonate, dimethyl carbonate, diethyl carbonate, or vinylene carbonate. These are merely examples, and the electrolyte, the solvent, and the additive may be selected and changed as appropriate.

When the target battery 10 is a solid-state battery, a solid electrolyte is disposed inside the laminate material 22. Known examples of the solid electrolytes include oxide-based electrolyte and sulfide-based electrolytes, but solid-state batteries using other materials may also be applicable to the present disclosure. The solid electrolyte in the solid-state battery is disposed, for example, between the positive electrode plate 11 and the negative electrode plate 12 in place of the separator 13. In this case, the solid electrolyte also has a function of preventing a short circuit between the positive electrode plate 11 and the negative electrode plate 12 in addition to a function as an electrolyte.

### [2. Peeling Apparatus]

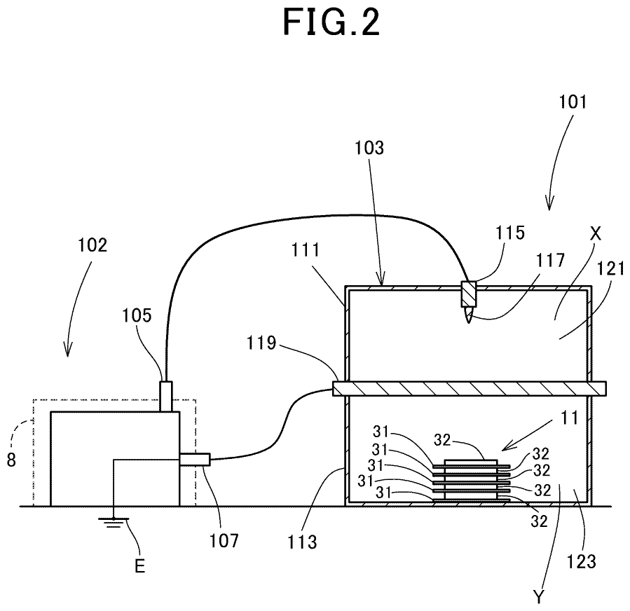

FIG. 2 is a schematic diagram of a peeling apparatus 101 for the positive electrode current collector 31 and the positive electrode composite 32.

The peeling apparatus 101 includes a power supply device 102 that generates electric power. The power supply device 102 outputs a large amount of electric power at a high voltage instantaneously for a short period of time, for example, microseconds or nanoseconds. A main body of the power supply device 102 is covered with a Faraday cage 8 that provides electromagnetic shielding. The power supply device 102 has, for example, a capacitor, stores a predetermined charge, and performs discharging instantaneously. The power supply device 102 includes an output terminal 105 that outputs a pulse voltage. The power supply device 102 is connected to an electrical ground E that electrically connects the device itself to the ground side. The power supply device 102 includes a ground terminal 107 connected to the electrical ground E.

The peeling apparatus 101 includes an apparatus main body 103. The apparatus main body 103 is a hollow container made of a metal such as stainless steel. The apparatus main body 103 is illustrated in a partial cross-sectional view in FIG. 2. A hollow interior of the apparatus main body 103 is partitioned by a partition plate 119. The partition plate 119 is a ground, and is a flat plate made of a metal such as stainless steel. In the present embodiment, an upper area of the partition plate 119 forms a current-carrying area 111 that generates shock waves, and a lower area of the partition plate 119 forms a shock wave delivery area 113 that deliveries shock waves to the positive electrode plate 11.

The current-carrying area 111 includes, at an upper part thereof, an electrode support portion 115 and an electrode 117 supported at a lower end of the electrode support portion 115. The Electrode 117 is electrically connected to the output terminal 105 of the power supply device 102. A current-carrying space 121 of the current-carrying area 111 is filled with water or an organic liquid (first liquid X) such as oil. The partition plate 119 is electrically connected to the ground terminal 107 of the power supply device 102.

A peeling space 123 of the shock wave delivery area 113 is filled with a liquid (second liquid Y) such as water. The positive electrode plate 11 is disposed in the peeling space 123. The positive electrode plate 11 is formed by the positive electrode current collector 31 and the positive electrode composite 32, and a plurality of positive electrode plates 11 are disposed in the peeling space 123 in a vertically stacked state.

In the peeling apparatus 101, when electric field intensity generated by the power supply device 102 exceeds a dielectric breakdown limit of the first liquid X filled in the current-carrying area 111, a discharge occurs between the electrode 117 of the current-carrying area 111 and the partition plate 119 to generate shock waves.

The shock waves generated in the current-carrying area 111 propagate through the partition plate 119 to the second liquid Y in the shock wave delivery area 113.

### [3. Operations and Effects]

Next, a description will be given with respect to operations and effects when the positive electrode composite 32 is peeled off from the positive electrode current collector 31 of the positive electrode plate 11. The positive electrode plate 11 is separated from the target battery 10 by a known technique and is disposed in the shock wave delivery area 113.

When a discharge occurs between the electrode 117 and the partition plate 119, the first liquid X in a discharge path instantaneously turns into bubbles, and shock waves are generated. The shock waves propagate through the first liquid X to the partition plate 119, propagate through the partition plate 119 to the second liquid Y, and finally propagate through the second liquid Y to the positive electrode plate 11. When the current is repeatedly carried by the power supply device 102, a discharge repeatedly occurs in the discharge path, shock waves are generated, and the positive electrode composite 32 is peeled off from the positive electrode current collector 31 of the positive electrode plate 11 by the shock waves 31. After the current is repeatedly carried by a predetermined number of times and the peeling is completed, the shock wave delivery area 113 is removed, and the water therein and the positive electrode current collector 31 and the positive electrode composite 32 peeled off from each other are selectively recovered.

When the shock wave delivery area 113 is newly filled with water, the positive electrode plate 11 is placed thereon, and a current is repeatedly carried by the power supply apparatus 102, the positive electrode composite 32 can be continuously peeled off from the positive electrode current collector 31.

In order not to attenuate the energy of the shock waves, the first liquid X is preferably a liquid that easily conducts the shock waves. Herein, a liquid having a greater density than water is used, for example. In order to increase the energy of the shock waves, the first liquid X is preferably a liquid having high dielectric strength. Furthermore, since the dielectric strength decreases when the metal forming the partition plate 119 dissolves, the first liquid X is preferably one having a lower solubility for such a metal than water. Since the metal on the surface of the partition plate 119 can be crushed by an impact force due to carrying of the current, the metal is particularly likely to dissolve within the current-carrying area 111. From such a viewpoint, the first liquid X is particularly preferably an organic liquid.

When the peeling apparatus 101 is configured such that the current-carrying area 111 and the shock wave delivery area 113 are integrally formed, the dielectric breakdown intensity of the liquid is reduced due to the electrolyte contained in the positive electrode plate 11, and the discharge path between the electrode 117 and the partition plate 19 increases, whereby the shock waves may weaken.

Furthermore, when fragments of the metal forming the peeling apparatus 101 are scattered due to carrying of the current, the metal may be mixed in. For example, when the partition plate 119 is formed of stainless steel, iron and chromium are mainly mixed in.

In the present embodiment, since the current-carrying area 111 and the shock wave delivery area 113 are partitioned from each other, the metal forming the partition plate 119 is not mixed in due to the shock waves, and the positive electrode current collector 31 and the positive electrode composite 32 can be effectively separated from each other.

### Configurations to be Supported by Above-Described Embodiment

The above-described embodiment supports Configurations below.

(Configuration 1) A peeling apparatus for a positive electrode current collector and a positive electrode composite, the peeling apparatus including: a current-carrying area including an electrode; a shock wave delivery area configured to house a positive electrode plate; a partition plate configured to partition between both the areas; and a power supply device configured to supply electric power to the electrode, the peeling apparatus being configured to peel off the positive electrode composite from the positive electrode current collector of the positive electrode plate in such a manner that a discharge occurs between the electrode and the partition plate and a shock wave generated in the current-carrying area is delivered through the partition plate to the positive electrode plate in the shock wave delivery area.

According to Configuration 1, the electrode, which is a generation source of shock waves, is partitioned from the positive electrode plate. For this reason, the constituent materials of the positive electrode plate do not affect carrying of a current in the current-carrying area. In addition, it is possible to prevent the materials from being mixed into the shock wave delivery area from the current-carrying area. Therefore, it is possible to effectively separate the positive electrode current collector and the positive electrode composite from each other.

(Configuration 2) The peeling apparatus for a positive electrode current collector and a positive electrode composite according to Configuration 1, in which the partition plate is made of stainless steel.

According to Configuration 2, since the materials is prevented from being mixed into the shock wave delivery area from the current-carrying area, it is possible to prevent the stainless steel from being mixed into the positive electrode current collector or the positive electrode composite.

(Configuration 3) The peeling apparatus for a positive electrode current collector and a positive electrode composite according to Configuration 1 or 2, in which the current-carrying area is filled with a liquid with a high dielectric breakdown limit.

According to Configuration 3, since a current-carrying path is not dispersed, the force of shock waves is stable, and efficient peeling can be performed.

(Configuration 4) The peeling apparatus for a positive electrode current collector and a positive electrode composite according to Configuration 1, in which the current-carrying area is filled with water or an organic liquid such as oil.

According to Configuration 4, since a current-carrying path is not dispersed, the force of shock waves is stable, and efficient peeling can be performed.

(Configuration 5) The peeling apparatus for a positive electrode current collector and a positive electrode composite according to Configuration 1, in which the shock wave delivery area is filled with water. According to Configuration 5, the positive electrode plate is easily placed and recovered.

### REFERENCE SIGNS LIST

10 . . . target battery; 11 . . . positive electrode plate; 12 . . . negative electrode plate; 13 . . . separator; 21 . . . laminated electrode; 22 . . . laminate material; 23A, 23B . . . current collector tab; 31 . . . positive electrode current collector; 32 . . . positive electrode composite; 41 . . . negative electrode current collector; 42 . . . negative electrode composite; 101 . . . peeling apparatus; 102 . . . power supply apparatus; 103 . . . apparatus main body; 105 . . . output terminal; 107 . . . ground terminal; 111 . . . current-carrying area; 113 . . . shock wave delivery area; 115 . . . electrode support portion; 117 . . . electrode; 119 . . . partition plate; 121 . . . current-carrying space; 123 . . . peeling space; E . . . electrical ground; X . . . first liquid; Y . . . second liquid.

1. A peeling apparatus for a positive electrode current collector and a positive electrode composite, the peeling apparatus comprising:
a current-carrying area including an electrode;
a shock wave delivery area configured to house a positive electrode plate;
a partition plate configured to partition between both the areas; and
a power supply device configured to supply electric power to the electrode,
the peeling apparatus being configured to peel off the positive electrode composite from the positive electrode current collector of the positive electrode plate in such a manner that a shock wave generated in the current-carrying area is delivered through the partition plate to the positive electrode plate in the shock wave delivery area.

2. The peeling apparatus for a positive electrode current collector and a positive electrode composite according to claim 1, wherein
the partition plate is made of stainless steel.

3. The peeling apparatus for a positive electrode current collector and a positive electrode composite according to claim 1, wherein
the current-carrying area is filled with a liquid with a high dielectric breakdown limit.

4. The peeling apparatus for a positive electrode current collector and a positive electrode composite according to claim 1, wherein
the current-carrying area is filled with water or an organic liquid such as oil.

5. The peeling apparatus for a positive electrode current collector and a positive electrode composite according to claim 1, wherein
the shock wave delivery area is filled with water.
